(19) United States
(12) Patent Application Publication
(10) Pub. No.: US 2012/0167873 A1
(43) Pub. Date: Jul. 5, 2012

(54) SOLAR POWERED HEATING SYSTEM FOR WORKING FLUID

(75) Inventors: Milton Venetos, Los Altos, CA (US); David C.V. Hawkins, Dee Why (AU); William M. Conlon, Palo Alto, CA (US); Charles S.J. Pickles, Mesa, AZ (US)

(73) Assignee: AREVA Solar, Inc.

(21) Appl. No.: 13/381,356

(22) PCT Filed: Jul. 8, 2010
(86) PCT No.: PCT/US10/41301

§ 371 Date: Mar. 16, 2012

Related U.S. Application Data
(60) Provisional application No. 61/270,526, filed on Jul. 8, 2009.

(51) Int. Cl. F24J 2/42; B23P 15/26; F24J 2/00

(52) U.S. Cl. 126/609; 126/714; 29/890.033

(57) ABSTRACT

A working fluid heating system that utilizes solar energy and fuel-fired heaters to heat the working fluid is provided. The system may have a fuel heating plant that has a first fuel-fired heater to heat a first portion of working fluid, a solar heating plant that has both a solar thermal-energy heater and a second fuel-fired heater to heat a second portion of working fluid. The first and second portions may join in a pipeline to supply heated working fluid to a facility such as an electrical generation facility, desalination facility, petrochemical facility, enhanced oil recovery facility, or air conditioning facility.

### CROSS-REFERENCE TO RELATED APPLICATIONS

This application claims the benefit of priority from U.S. provisional patent application entitled “Solar Powered Heating System for Working Fluid”, application Ser. No. 61/270,526, inventors Milton Venetos, David C. V. Hawkins, William M. Conlon, and Charles S. J. Pickles, filed on Jul. 8, 2009, which is hereby incorporated by reference in its entirety for all purposes as if put forth in full below.

### BACKGROUND

1. Field

This application relates generally to solar-powered heating systems (e.g., solar-powered boiler systems) and facilities (e.g., electrical power generation, air conditioning, desalination, petrochemical processing, and enhanced oil recovery facilities) incorporating such systems.

2. Related Art

Alternative sources of energy are needed to continue supplying energy for many processes to accommodate an ever-increasing population world-wide. One such source of energy is solar energy, as it is readily available in certain geographic areas and can be used to perform work or provide heat for use in many industrial processes. For instance, the heat available from solar energy may be harnessed and used to increase temperature, and optionally pressure, of a working fluid, such as water or oil, to supply high-temperature working fluid. The working fluid may then be supplied, for example, to a turbine for generating electricity.

However, turbines are generally sensitive to the pressure and temperature of the input working-fluid. For instance, increasing the working-fluid inlet pressure and temperature increases turbine efficiency. Conversely, decreasing the working-fluid inlet pressure and temperature decreases turbine efficiency. This creates a problem for solar energy systems since the amount of thermal energy produced by the system depends on the amount of sunlight available. Unfortunately, the amount of sunlight varies based on the time of day, time of year, weather, and the like. Thus, the thermal energy output of solar energy systems is inconsistent and unreliable.

As a result of the problem discussed above, many conventional steam turbine power generation facilities use a solar plant as an auxiliary heating system for a main fuel-based plant. For example, EP0784157 describes a power generation facility having a parallel arrangement of a solar power plant and full fuel heating plant for heating a working fluid flowing into a steam turbine plant. However, the solar plant is simply used as an auxiliary heating plant, for example, as an economizer or superheater, for the main full fuel heating plant. Thus, the solar plant is not independent from the full fuel plant as the system includes a common fuel/solar portion. As a result, the solar plant cannot be used without operating a full fuel heating plant.

Thus, a solar-powered heating system that may operate independently from a main full fuel heating plant is desired.

### BRIEF SUMMARY

Various embodiments related to heating systems are provided herein. The system may include a first pipeline configured to carry a working-fluid to a fuel heating plant comprising a first fuel heater. The system may further include a solar heating plant in parallel with the fuel heating plant and configured to receive at least a portion of the working-fluid carried by the first pipeline. The solar heating plant may comprise a solar heater and a second fuel heater downstream from the solar heater. The second fuel heater may be independent from the first fuel heater. The system may further include a second pipeline configured to receive the working-fluid from the solar heating plant and the fuel heating plant. The second pipeline may be configured to carry the working-fluid to a turbine for generating electricity.

In some embodiments, the solar heating plant and the fuel heating plant may be configured to output the working-fluid at a predetermined temperature and at a predetermined pressure. In some embodiments, the second fuel heater may be configured to provide a maximum of 25% of the heat needed to get the working fluid to the predetermined temperature and predetermined pressure. In other embodiments, less than 2% of the heat in the heated working fluid is provided by the first fuel heater and the second fuel heater.

In some embodiments, the first fuel heater may include a fuel fired boiler configured to economize, evaporate, and superheat the working-fluid. The second fuel heater may include an economizer and superheater. In other embodiments, the second fuel heater may include a pre-heater section.

Methods and computer-readable storage media for operating heating systems are also provided herein.

Methods are provided for converting a full fuel-fired heating plant into a hybrid solar/fuel heating plant. In some embodiments, the method includes providing a solar heating plant, connecting an input of the solar heating plant to an input of the full fuel-fired heating plant, and connecting an output of the solar heating plant to an output of the full fuel-fired heating plant.

Methods are also provided for converting a solar heating plant into a hybrid solar/fuel heating plant. In some embodiments, the method includes providing a full fuel-fired heating plant, connecting an input of the full fuel-fired heating plant to an input of the solar heating plant, connecting an output of the full fuel-fired heating plant to an output of the solar heating plant.

### BRIEF DESCRIPTION OF THE DRAWINGS

FIG. 1 illustrates an exemplary power generation system.

FIG. 2 illustrates another exemplary power generation system.

FIG. 3 illustrates yet another exemplary power generation system.

FIG. 4 illustrates yet another exemplary power generation system.

FIG. 5 illustrates an exemplary process for converting a full fuel-fired heating plant into a hybrid solar/fuel heating plant.

FIG. 6 illustrates an exemplary process for converting a solar heating plant into a hybrid solar/fuel heating plant.

FIG. 7 illustrates an exemplary computing system that may be used to implement some or all processing functionality of various embodiments herein.

### DETAILED DESCRIPTION

While various specific configurations are discussed in detail below, the mode of operation, the associated equipment, and the various configurations may be applied individually, in combination, or collectively with systems, facilities, and methods as discussed herein. Consequently, the description of equipment and operational strategies in the context of particular configurations and operations is not to be limited to those discussed in the figures but is, instead, to be viewed as applying to each and every system, facility, and method disclosed herein as understood by a person of ordinary skill in the field.

The systems, facilities, and methods discussed herein may be sufficiently flexible in operation to provide a reliable supply of heated working fluid to perform useful work, either on demand or constantly or consistently during operation. The system may also allow for a higher overall rate of conversion of the collected solar energy to electricity.

As discussed above, the working-fluid inlet pressure and temperature may affect the efficiency of a turbine. For instance, lowering inlet pressure reduces turbine efficiency and increases usage of working fluid for a given amount of work. For some turbines, a 10% increase in inlet steam pressure may correspond to about 1.5% increase in efficiency in the turbine. Additionally, a condensing turbine may have an efficiency of about 37% when the working fluid is steam at 370° C. and 100 bar, whereas the same turbine has an efficiency of about 41% when the working fluid is steam at 540° C. and 100 bar. Thus, there is about a 1% increase in efficiency for each 40° C. increase in inlet steam temperature. A system as disclosed herein may therefore increase utilization of solar energy by increasing overall efficiency of utilization of heat.

Various embodiments are provided below relating to solar-powered heating systems. The systems may utilize solar energy and fuel-fired heaters to heat the working fluid. The system may have a fuel heating plant that has a first fuel-fired heater to heat a first portion of working fluid, a solar heating plant that has both a solar thermal-energy heater and a second fuel-fired heater to heat a second portion of working fluid. The first and second portions may join in a pipeline to supply heated working fluid to a facility such as an electrical generation facility, desalination facility, petrochemical facility, enhanced oil recovery facility, or air conditioning facility.

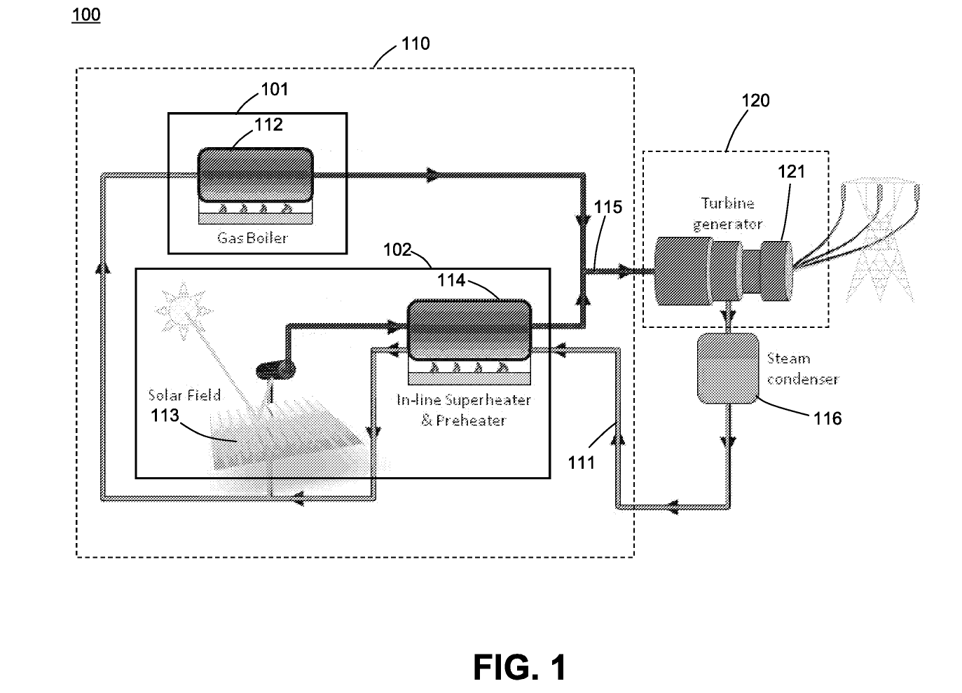

FIG. 1 illustrates an exemplary power generation system 100 for generating electricity. Electrical power generation system 100 includes working-fluid heating system 110 and electrical generator 120. Electrical generator 120 may include turbine 121 and a DC or AC electricity generator, such as a dynamo or an AC electric power generator such as an alternator. The generator may be configured to provide, for example, about or more than about 1, 5, 10, 15, 20, 25, 30, 35, 40, 45, 50, 75, 100, 200, 250, 300, 400, 450, 500 MW of electricity, or more, if desired, and multiples of each thereof.

Working fluid heating system 110 includes first pipeline 111, first working-fluid heater 101 (also referred to at times herein as “first heater”), second working-fluid heater 102 (also referred to at times herein as “second heater”), and second pipeline 115. First working-fluid heater 101 comprises one or more fuel-fired heaters, such as the depicted natural gas-fired boiler 112. Second working-fluid heater 102 comprises one or more solar thermal energy heaters 113 (also referred to at times herein as “solar heater”) and one or more fuel-fired heaters 114. Power generation system 100 also includes steam condenser 116 for condensing steam from turbine 121 and is in fluid communication with first pipeline 111 to recycle water to working-fluid heating system 110. For sake of convenience, the one or more fuel-fired heaters of the first working-fluid heater 101 are referred to collectively as “first fuel-fired heater 112” and the one or more fuel-fired heaters of the second working-fluid heater 102 are referred to collectively as “second fuel-fired heater 114.”

First pipeline 111 contains a working fluid, such as water, which may be preheated, if desired, in a preheating portion of second fuel-fired heater 114. All of the working fluid may be sent to first working-fluid heater 101, all of the working fluid may be sent to second working-fluid heater 102, or the working fluid may be divided into a first and second portion that pass through each of their respective heaters. Where the working fluid stream is split, either of the first and second heaters 101 and 102 may not be in operation or may be idling to provide minimal heat to its respective fluid stream.

Often, it is desirable for most, or all, of the heat to be supplied by solar heater 113. Consequently, solar heater 113 may be of a size that at least, for example, about 75%, about 90%, or all of the heat needed for the work demand (e.g., electrical generator) is supplied to the working fluid by solar heater 113 while first and second fuel-fired heaters 112 and 114 are either shut off, idled, or operated to supplement heating as needed. Second fuel-fired heater 114 may actively heat the second portion of working fluid emerging from solar heater 113 to assure the heated working fluid has sufficient energy to meet demand or to assure that the heating working fluid has a desired temperature and pressure. For example, if water/steam is used as the working fluid, second fuel-fired heater 114 may actively heat the second portion of steam or hot water emerging from solar heater 113 to assure that the steam, when exiting the fuel-fired heater, has a desired quality or temperature at a desired operating pressure. The temperature and pressure of the working fluid exiting second fuel-fired heater 114 may be selected so as to provide inlet fluid conditions sufficient to allow a turbine to operate at a desired efficiency or in a desired efficiency range, for example, for a condensing turbine, an efficiency of at least about 35%, 36%, 37%, 38%, 39%, 40%, 41%, 42%, or more. In some variations, second fuel-fired heater 114 operates so that superheated steam exits second fuel-fired heater 114, where the superheated steam is at a pressure of about 90 bar, 100 bar, 110 bar, 120 bar, or more, and the temperature of the superheated steam is about 350° C., 370° C., 390° C., 400° C., 420° C., 440° C., 460° C., 480° C., 500° C., 520° C., 540° C., 560° C., or more. In some variations, second fuel-fired heater 114 may be configured so that superheated steam at or about 100 bar and 540° C. exits second fuel-fired heater 114. First fuel-fired heater 112 may be used to heat the first portion of working fluid where, for example, solar heater 113 is heating below its capacity because of clouds or maintenance or to meet peak demand requirements. First fuel-fired heater 112 may be selected and operated so that the temperature and pressure of the portion of the working fluid exiting first fuel-fired heater 112 is generally matched to that exiting second fuel-fired heater 114.

Solar heater 113 may or may not heat the working fluid sufficiently to cause the fluid to change phase. Solar heater 113 may comprise a boiler, such as a steam boiler, and where configured as a steam boiler, the steam emerging from the solar boiler may be saturated or superheated. In some examples, solar heater 113 may be configured to produce steam at 370° C. and 120 bar. Second fuel-fired heater 114 is typically positioned to receive the second portion of working fluid that has been heated by solar heater 113. As described above, second fuel-fired heater 114 may therefore improve the “quality” of the second portion of working fluid by adding heat to further increase temperature or pressure of the second portion of the working fluid. Second fuel-fired heater 114 may therefore also cause some or all of the second portion of the working fluid to change phase, or this heater may add more heat without changing phase of the second portion of working fluid.

First fuel-fired heater 112 may or may not heat the working fluid sufficiently to cause the fluid to change phase. Typically first fuel-fired heater 112 has a size and capacity sufficient to heat the first portion of working fluid to match properties of the second portion of working fluid that emerges from second working-fluid heater 102. The first portion of working fluid will typically therefore have the same, or at least a substantially similar, temperature and pressure emerging from first working-fluid heater 101 as the second portion of working fluid emerging from second working-fluid heater 102. In some examples, the difference between the temperature and pressure of the working-fluid emerging from first working-fluid heater 101 may differ by less than 10%, 5%, 4%, 3%, 2%, 1%, 0.5%, or less, from the temperature and pressure of the working fluid emerging from second working-fluid heater 102. Second fuel-fired heater 114 may optionally have a preheat section, in which working fluid is pre-heated with little or no phase change prior to being fed to solar heater 113.

Solar heater 113 typically has a capacity to provide at least 50% of the heat in the heated working fluid. In some embodiments, the heat generating capacity of solar heater 113 is more, for example, at least 55%, 60%, 65%, 70%, 75%, 80%, 85%, 90%, 95%, 96%, 97%, 98%, 99%, or all of the heat in the heated working fluid. In these embodiments, most, or all, of the working fluid passes through second working-fluid heater 102, for example, at least 55%, 60%, 65%, 70%, 75%, 80%, 85%, 90%, 95%, 96%, 97%, 98%, 99%, or all of the working fluid passes through second working-fluid heater 102. The percentage of solar heat utilized may be calculated on an instantaneous basis or as an hourly, solar day, operational period, weekly, monthly, or annual average.

Power generation system 100 may be configured so that the fuel-fired heaters together provide less than about 5, 10, 15, 20, 25, 35, 40, or 45 percent (e.g., less than about 25 percent) of the heat in the first and second portions of working fluid supplied to second pipeline 115. Consequently, the first and second fuel-fired heaters 112 and 114 may be configured to burn an amount of fuel such as natural gas, propane, coal, oil, biomass, landfill gas (e.g., methane) or any suitable waste fuel (e.g., refuse, tires, and the like), to supply less than about 5, 10, 15, 20, 25, 35, 40, or 45 percent (e.g., less than about 25 percent) of the heat in the first and second portions of the working fluid. The percentage of solar heat utilized may be calculated on an instantaneous basis or as an hourly, solar day, operational period, weekly, monthly, or annual average.

Second fuel-fired heater 114, which works in conjunction with solar heater 113, may therefore provide little or no heat to the second portion of working fluid in some instances or under some operating conditions. Second fuel-fired heater 114 may have a pre-heat section configured to preheat working fluid fed to solar heater 113 with little or no phase change prior to being introduced to solar heater 113. Second fuel-fired heater 114 is typically downstream of solar heater 113. Second fuel-fired heater 114 may operate to assure that the working fluid emerging from second working-fluid heater 102 or the heated working fluid being used to perform work has a consistent temperature and pressure to provide the amount of work to be performed with the working fluid and to meet the inlet steam specifications of turbine 121.

For instance, as clouds temporarily reduce output from solar heater 113, the amount of heat supplied by second fuel-fired heater 114 increases to compensate for the heat blocked by the clouds, and likewise with haze, fog, dust, and the like. If a storm, large number of clouds, time of day, or time of year, reduces output from solar heater 113 substantially, more heat may be added by second fuel-fired heater 114. Alternatively, or additionally, first fuel-fired heater 112 may supplement heating by directly heating the first portion of working fluid to the desired temperature and pressure to supplement or bypass solar heater 113 and second fuel-fired heater 114, assuring a more consistent quality of working fluid to turbine 121. Coordination of first and second fuel-fired heaters 112 and 114 may be set so as to provide a stable supply of a selected temperature and pressure of working fluid to the inlet of turbine 121 to achieve desired performance of the turbine, yet to reduce the amount of fossil fuel consumed.

First fuel-fired heater 112 may thus have a greater heating capacity than second fuel-fired heater 114 due to the need to heat the first portion of working fluid directly to working conditions without the aid of solar energy. Alternatively, second fuel-fired heater 114 may have a greater heating capacity than first fuel-fired heater 112 due to a larger amount of working fluid passing through second fuel-fired heater 114, or the heating capacity of each heater may be the same.

Using two fuel-fired heaters 112 and 114, as described above, allows system 100 to generate electricity under any sunlight conditions (e.g., day, night, sunny, cloudy, etc.) when using water as the working fluid. For instance, first fuel-fired heater 112 of first working-fluid heater 101 may be used to produce enough steam to run electrical generator 120 at full capacity when there is insufficient sunlight to operate solar heater 113. However, when there is sufficient sunlight to operate solar heater 113, second working-fluid heater 102 may be used alone or in conjunction with first working fluid heater 101 to produced steam to run electrical generator 120. This may not be possible with conventional single-heater systems, for example systems having a solar heater in series with an inline heater. This is due to the fact that conventional heaters typically require a designated section of the heater to evaporate water. In conventional systems, like the solar heater/inline heater system described above, the inline heater would require an evaporator to operate during times when there is insufficient sunlight to evaporate the water in the solar heater. However, the heater would also need an internal bypass to bypass the evaporator when the solar heater receives enough sunlight to evaporate the water. Such heaters are currently unavailable, and if created, would likely be very expensive.

Thus, in some embodiments, second fuel-fired heater 114 may comprise an inline superheater and economizer, with no evaporator. In these embodiments, second fuel-fired heater 114 may only boost the temperature of steam exiting solar heater 113. First fuel-fired heater 112 may comprise a conventional fuel-fired boiler configured to economize, evaporate, and superheat the feedwater. Thus, first fuel-fired heater 112 may operate at full capacity even when solar heater 113 is not operating.

In some embodiments, heated working fluid from one or both of first fuel-fired heater 112 and second fuel-fired heater 114 may be used to preheat solar heater 113 when solar heater 113 has been idle for a period of time, such as in the morning or after maintenance has been performed. An additional pipe may connect the outlet of first fuel-fired heater 112 with the inlet of solar heater 113, for instance, to pass heated working fluid such as steam into solar heater 113, and second fuel-fired heater 114 may heat this steam and any condensate to the desired temperature and pressure before the steam enters second pipeline 115. Alternatively, or additionally, an additional pipe may connect the outlet of second fuel-fired heater 114 with the inlet for solar heater 113 to recycle heated working fluid through solar heater 113 before reheating the working fluid in second fuel-fired heater 114.

As noted above, solar heater 113 in any of the configurations discussed herein may be a linear Fresnel reflector (LFR) array. LFR arrays are discussed and depicted in U.S. Pat. Nos. 5,899,199 and 6,131,565 and U.S. application Ser. No. 10/597,966 and 10/563,171, each of which is incorporated by reference in its entirety for all that it discloses and is therefore to be read as if put forth in full below. Other particular configurations of LFR arrays that may be incorporated into systems and facilities herein include those disclosed in: PCT application serial number PCT/US2008/010230 entitled “Linear Fresnel Solar Arrays” filed on Aug. 27, 2008; PCT application serial no. PCT/US2008/010223 entitled “Linear Fresnel Solar Arrays and Components Therefor” filed Aug. 27, 2008; U.S. application Ser. No. 12/012,829 entitled “Linear Fresnel Solar Arrays and Receivers Therefor” filed Feb. 5, 2008; U.S. application Ser. No. 12/012,821 entitled “Linear Fresnel Solar Arrays and Drives Therefore” filed Feb. 5, 2008; PCT application serial no. PCT/AU2004/000884 entitled “Carrier for a Solar Energy Reflector Element” filed Jul. 1, 2004; PCT application serial no. PCT/AU2004/000883 entitled “Carrier and Drive Arrangement for a Solar Energy Reflector System” filed Jul. 1, 2004; and PCT application serial no. PCT/AU2005/000208 entitled “Multi-Tube Solar Collector Structure” filed Feb. 17, 2005, each of which is incorporated by reference in its entirety for all that it discloses and is therefore to be read as if put forth in full below. In a LFR array, multiple rows of flat or curved (e.g., parabolically cross-sectioned) mirrors mounted on reflector structures reflect light to a single receiver elevated above the reflector structure rows. Each row typically rotates about a pivot line parallel to the row but in most instances is not free to move in any other manner. The receiver therefore typically has one degree of freedom (roll). The receiver may have a single tube through which the working fluid (e.g., water or steam) flows, or the receiver may have multiple tubes through which the working fluid (e.g., water or steam) flows. The receiver may or may not have one or more reflectors associated with it to capture light reflected by the reflector structures and to aid in illuminating the one or more receiver tubes with reflected light that might otherwise not perform useful work if not redirected. The number of reflectors focused on a receiver tube and the size of the LFR array (e.g., number of receivers in the array or length of the receiver and reflector rows) may be selected to provide heated working fluid, such as water, saturated working fluid, such as saturated steam, or superheated working fluid, such as superheated steam exiting the solar heater. The tubes may be constructed of a material selected to meet local or national boiler codes for the operating temperature and pressure conditions of the system. For example, carbon steel tubes may be used for systems operating at 100 bar or higher and temperatures of about 300° C. or higher.

A solar heater may instead or additionally be a trough array. Trough arrays are discussed and depicted in U.S. Pat. No. 7,296,410, for example, and is incorporated by reference in its entirety for all that it discloses and is therefore to be read as if put forth in full below. In a trough array, a single row of curved (e.g., parabolically) mirrors in cross-section reflect light to a single receiver associated with the mirror row. Like the LFR array, each row of a trough array typically rotates about a pivot line parallel to the row but is constrained with respect to other possible movement and therefore has only one degree of freedom (roll). However, there is a 1:1 correspondence of reflector row and receiver in a trough array, whereas in a LFR system the number of reflector rows per receiver is greater than 1. The length and number of rows of reflectors focused on receiver tubes may be selected to provide heated working fluid, saturated working fluid, or superheated working fluid exiting the solar heater as explained herein.

A solar heater may instead or additionally be a parabolic dish solar heater. Such dish heaters are discussed and depicted in U.S. Pat. No. 7,051,529, for example, and is incorporated by reference in its entirety for all that it discloses and is therefore to be read as if put forth in full below. A mirror of a parabolic dish solar collector is typically parabolically shaped in all cross-sections drawn through the focal point, whereas a mirror of a trough or LFR array is typically parabolic only in the cross-section drawn perpendicular to a length of the mirror. The dish also typically tracks the sun by moving in more than one direction and therefore has more than one degree of freedom. The size of the dish focusing on its solar energy receiving reservoir and the number of these solar heaters placed in series or in parallel may be selected to provide heated working fluid, saturated working fluid, or superheated working fluid exiting the solar heater as explained herein.

A solar heater may instead or additionally be a power tower. Such power towers are discussed and depicted in U.S. Pat. No. 6,931,851, for example, and is incorporated by reference in its entirety for all that it discloses and is therefore to be read as if put forth in full below. In a power tower, a number of heliostats are positioned around a tower to focus light to a receiving reservoir at the focus of the heliostats. The heliostats typically track the sun in more than one direction and therefore have more than one degree of freedom. The number and size of reflectors focusing on the tower may be selected to provide heated working fluid, saturated working fluid, or superheated working fluid exiting the solar heater as explained herein.

First solar heater 113 may comprise any of the systems described above, or any combination of these, such as a LFR array-parabolic trough array, a LFR array-solar power tower system, a LFR array-solar dish system, a parabolic trough array-solar power tower system, a parabolic trough array-solar dish system, a LFR array-parabolic trough array-solar power tower system, LFR array-parabolic trough array-solar dish system, or a parabolic trough array-solar power tower system-solar dish system.

A fuel fired heater, for example, first fuel-fired heater 112 and second fuel-fired heater 114, may comprise a coal fired heater, diesel or other liquid fuel fired heater, methane fired heater, propane fired heater, waste to energy or other heater. A coal fired heater or boiler utilizes pulverized coal as a fuel source to heat water passing through tubes in the burner section, heating the water and optionally heating the water sufficiently to produce saturated or superheated steam. A gas-fired heater or boiler uses a gas source such as natural gas or propane in place of coal as the fuel. A waste to energy heater uses a waste stream (e.g., biomass, medical waste, municipal/industrial solid waste, land fill gas, etc.) as the fuel. A fuel-fired heater may or may not include a preheat section that allows a working fluid to be preheated and sent to other processing equipment before being returned to the fuel-fired heater for subsequent boiling or superheating. Consequently, first fuel-fired heater 112, second fuel-fired heater 114, or both, may have any system as disclosed herein and may have a preheating section as part of the heater. First fuel-fired heater 112 and second fuel-fired heater 114 may comprise the same or different type of heater.

The working fluid used in power generation system 100 may be a liquid, a gas, or a liquid-gas mixture, for instance. Common examples are water, steam (saturated or superheated), or alternatively, an organic liquid or vapor or an inorganic liquid or vapor. If an alternative fluid such as an organic fluid or silicone-based fluid is used as a working fluid, the organic fluid may have a boiling point greater than about 150° C., 200° C., or 250° C. at the relevant operating pressure. The organic fluid may have a boiling point less than about 200° C., 300° C., or 400° C. at the relevant operating pressure. Examples of alternate working fluids include but are not limited to, various inorganic molten salts such as molten nitrate salts, mineral oils, fluids containing biphenyl or diphenyl oxide, glycol-based fluids, and silicone-based fluids. Working fluids from the Dowtherm™ family of heat transfer fluids, the Syltherm™ family of heat transfer fluids (both available from Dow Chemical Company, Midland, Mich.) and from the Therminol™ family of heat transfer fluids (available from Solutia, Inc., St. Louis, Mo.). In certain variations, the working fluid may be a vapor, such as air, nitrogen, helium, or carbon dioxide.

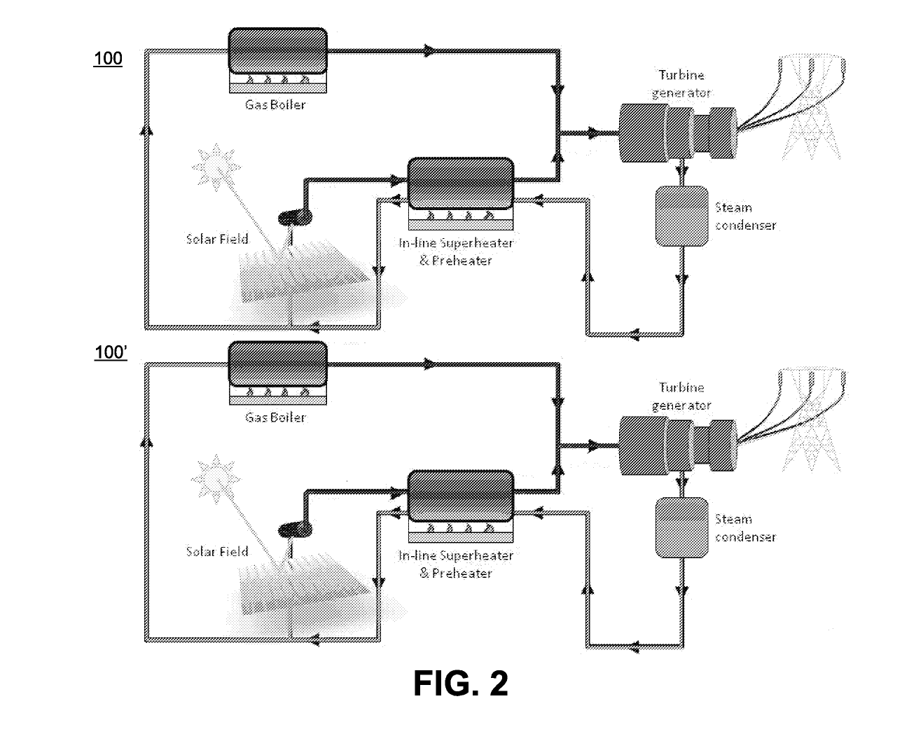

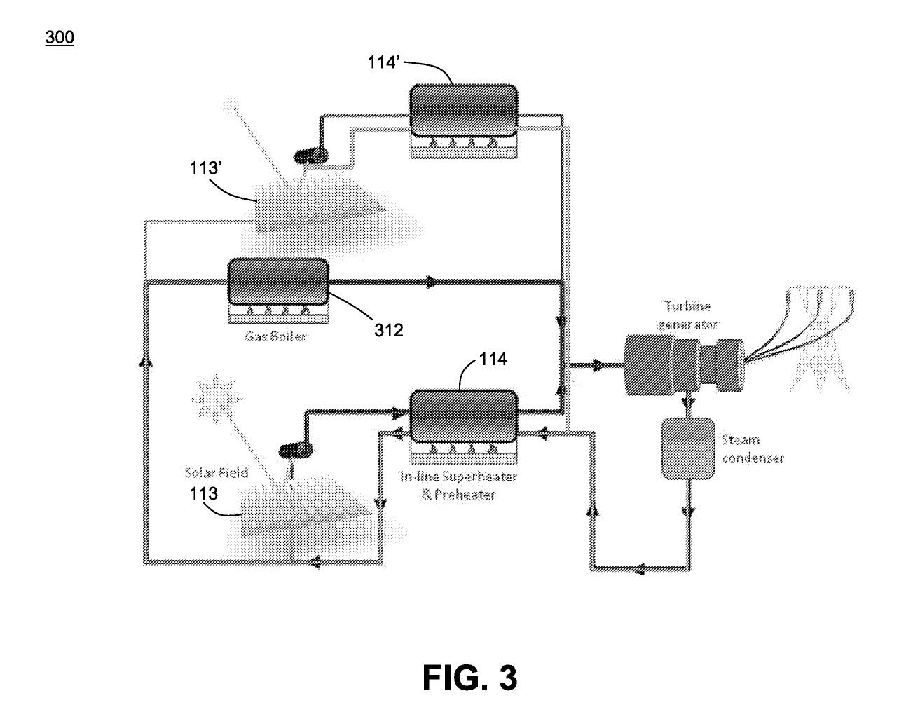

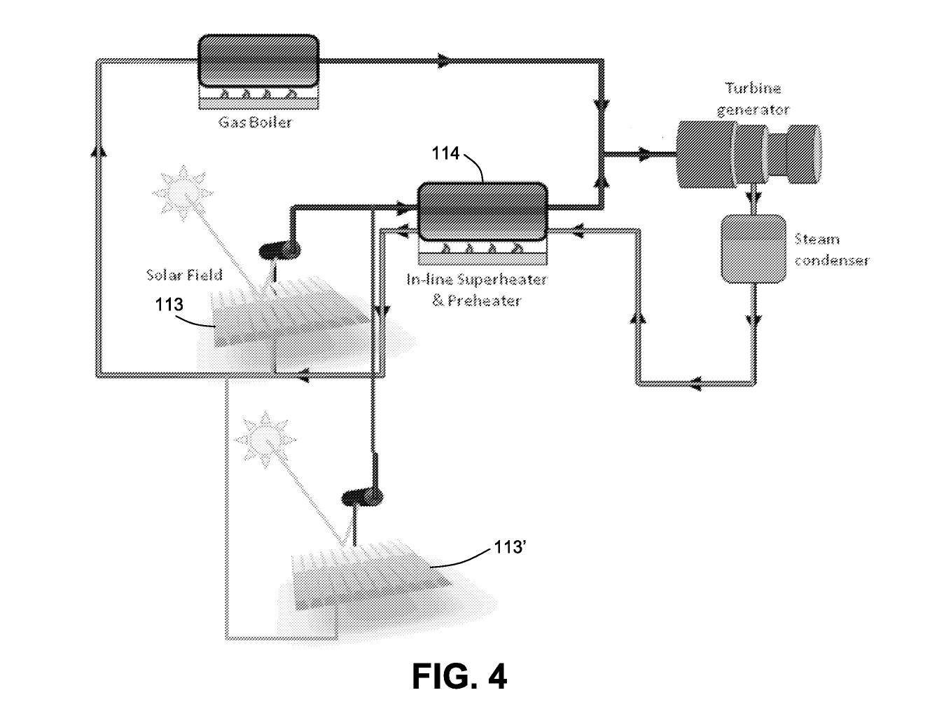

A facility may comprise one or a plurality of working-fluid heating systems as discussed above. The systems may be configured in parallel so that each system may be operated independently or together as needed as depicted in FIG. 2, in which system 100 of FIG. 1 is duplicated as 100 and 100′, along with associated equipment. The systems may also share common components. For instance, the first working-fluid heater (e.g., gas boiler 312 of FIG. 3) may be shared between a plurality of working-fluid heaters (e.g., a working fluid heater having solar heater 113 and superheater 114 and another working fluid heater having solar heater 113′ and superheater 114′) that utilize solar energy to heat a portion of the working fluid stream as depicted in FIG. 3. Alternatively, or additionally, the second working-fluid heater (e.g., in-line superheater and preheater 114 of FIG. 4) may be shared by a plurality of solar energy heaters 113 and 113′ as depicted in FIG. 4.

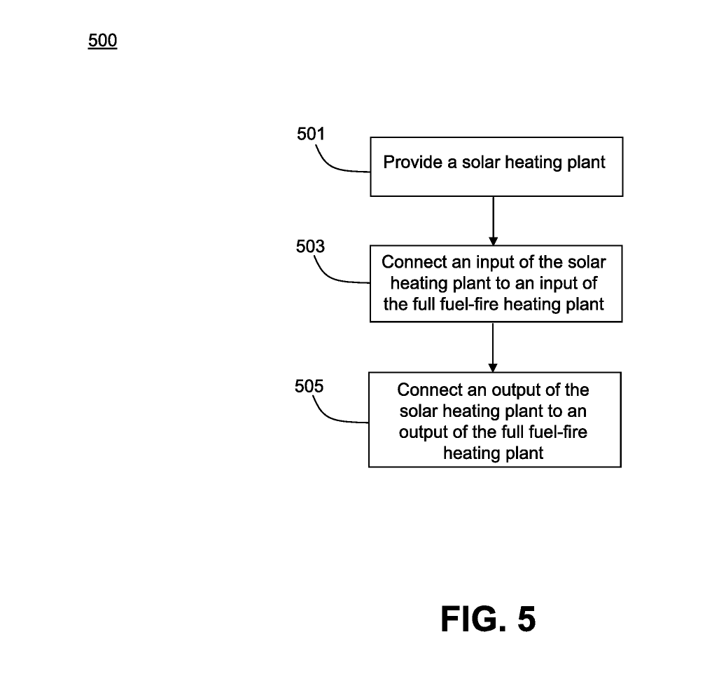

Using the configuration of the systems described above allows a conventional full fuel-fired heating plant to be modified into a hybrid solar/fuel system like that shown in FIGS. 1-3. For example, FIG. 5 illustrates an exemplary process 500 for converting a fuel-fired heating plant into a hybrid solar/fuel plant. At block 501, a solar heating plant, for example, a plant similar to second working-fluid heater 102 is provided. The solar heating plant may include a solar heater and a downstream fuel heater. The fuel heater of the solar heating plant may be independent from the fuel heater of the full fuel-fired heating plant. In other words, the fuel heater of the solar heating plant may be operated while the fuel heater of the full fuel-heating plant is idle or off, and vice versa. At block 503, an input of the solar heating plant may be connected to an input of the full fuel-fired heating plant. At block 505, an output of the solar heating plant may be connected to an output of the full fuel-fired heating plant. Thus, the solar heating plant and the full fuel-fired heating plant may be in parallel and working fluid may selectively be passed through either, or both, heating plants, similar to power generation system 100 described above with respect to FIG. 1. The full fuel-fired heating plant may therefore be modified into a hybrid solar/fuel plant without redesigning the full fuel-fired heating portion of the plant.

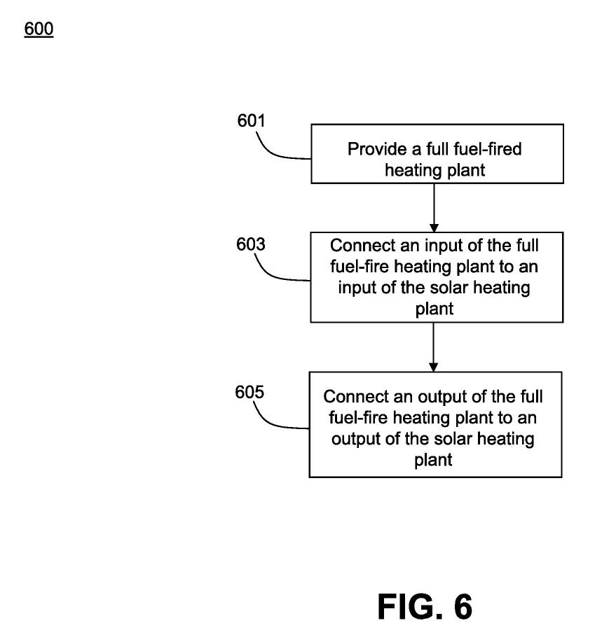

Similarly, a conventional solar heating plant may be modified into a hybrid solar/fuel system like that shown in FIGS. 1-3. For example, FIG. 6 illustrates an exemplary process 600 for converting a solar heating plant into a hybrid solar/fuel plant. At block 601, a full fuel-fired heating plant, for example, a plant similar to first working-fluid heater 101 is provided. The full fuel-fired heating plant may include a fuel heater separate from the fuel heater of the solar plant. In other words, the fuel heater of the full fuel-heating plant may be operated while the fuel heater of the solar heating plant is idle or off, and vice versa. At block 603, an input of the full fuel-fired heating plant may be connected to an input of the solar heating plant. At block 605, an output of the full fuel-fired heating plant may be connected to an output of the solar heating plant. Thus, the solar heating plant and the full fuel-fired heating plant may be in parallel and working fluid may selectively be passed through either, or both, heating plants, similar to power generation system 100 described above with respect to FIG. 1. The solar heating plant may therefore be modified into a hybrid solar/fuel plant without redesigning the solar heating portion of the plant.

A facility or system may be constructed in stages. Some equipment may be installed in a first phase of construction and then operated. Subsequently (e.g., one, two, three, four, five, six, seven or more years after initial construction or operation), other equipment may be installed to form a system or facility as discussed herein or to practice a method as discussed herein. For instance, most or all of the components of the system, but not including the second fuel-fired heater, may be sold and constructed on site. Later, the second fuel-fired heater may be installed to complete a system or practice a method as described herein.

Alternatively for instance, most or all components of the system, but not including the first fuel-fired heater, may be sold and constructed on site. Later, the first fuel-fired heater may be installed to complete a system or practice a method as described herein. In another instance, most or all components of the system, but not including the solar heater, may be sold and constructed on site. Later, the solar heater is installed to complete a system or practice a method as described herein.

Consequently, a system may be sold as a group of unassembled parts, or a system may be formed by providing a system lacking, for example, one of the fuel-fired heaters and installing the other fuel-fired heater into this system.

Any of the systems above may be configured to provide electricity or other work by coupling the working fluid to an electrical generator or absorption chiller as described previously or to a desalination unit, petrochemical plant, or enhanced oil recovery facility.

A desalination unit may be a reverse-osmosis water purifier, for instance, coupled to an electrical generator as described above or a thermal desalination system configured to receive heated working fluid from second pipeline 115. In enhanced oil recovery, steam as produced using, for example, a system as described herein, is introduced into oil wells through one or more steam injectors. Steam helps reduce oil viscosity and enable recovery of additional oil from formations. A petrochemical plant uses substantial quantities of steam. A system as described herein may attach to a steam distribution network or manifold that supplies steam to the various operations within the petrochemical plant. A food processing facility may include a working fluid heating system as discussed herein and a header to one or more food-processing vats or lines. The working fluid provides heat for sterilizing containers, cooking food, or otherwise processing food products.

An air conditioning system may comprise any of the working fluid heating systems discussed herein and an absorption chiller or a steam or electricity-driven mechanical chiller configured to receive heated working fluid from second pipeline 115. For example, an absorption chiller may have a compressor and a condenser in fluid communication with working-fluid heating system 110 wherein the condenser is configured to supply the working fluid to first pipeline 111 (either directly or through other equipment such as a condenser) and the compressor is configured to receive the working fluid from second pipeline 115 (either directly or through other equipment such as a reservoir).

A distillation system may comprise any of the working fluid heating systems discussed herein and one or more distillation columns in fluid communication with heated working fluid from second pipeline 115. For example, one or more distillation columns may receive steam from second pipeline 115 of working fluid heating system 110 to boil a liquid that flows through the distillation column(s) to separate components from the liquid.

A system or method as disclosed herein may of course be configured to provide all or part of the energy for an entire work demand, such that, for example, only one system is needed to perform all work or multiple systems in parallel provide sufficient heated working fluid to satisfy the entire demand. Therefore, a system or method as described above may cooperate with other equipment (such as other conventional or alternate energy-fueled boilers) and methods to provide all work to be performed. Thus, satisfying a work demand as discussed above does not necessarily imply that a heated stream as made using equipment and methods herein provides all work necessary to meet a particular work demand.

Those skilled in the art will recognize that the operations of some variations may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the apparatus and methods described herein.

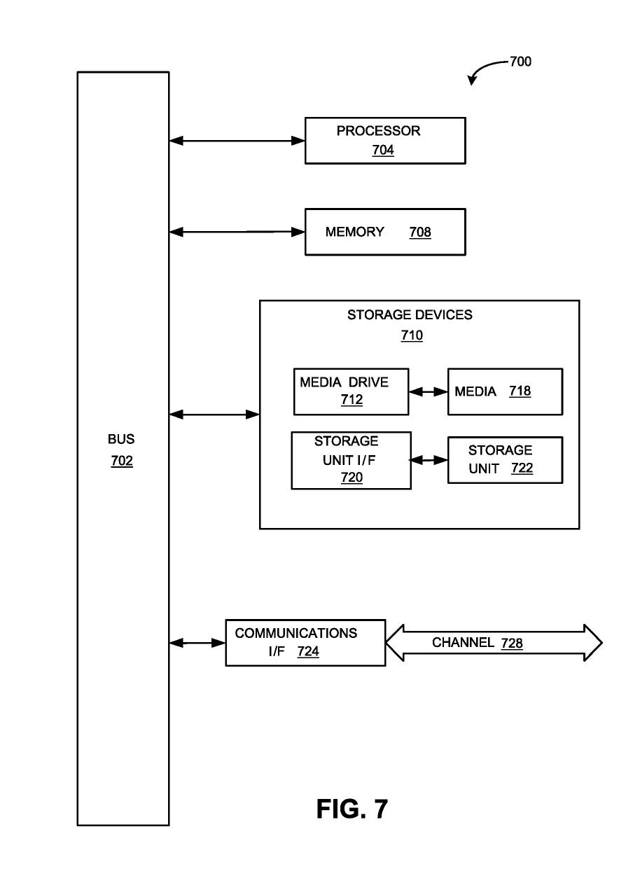

FIG. 7 illustrates a typical computing system 700 that may be employed to carry out processing functionality in some variations of the process. Those skilled in the relevant art will also recognize how to implement the apparatus and methods described herein using other computer systems or architectures. Computing system 700 may represent, for example, a desktop, laptop, or notebook computer, hand-held computing device (PDA, cell phone, palmtop, etc.), mainframe, supercomputer, server, client, or any other type of special or general purpose computing device as may be desirable or appropriate for a given application or environment. Computing system 700 can include one or more processors, such as a processor 704. Processor 704 can be implemented using a general or special purpose processing engine such as, for example, a microprocessor, controller or other control logic. In this example, processor 704 is connected to a bus 702 or other communication medium.

Computing system 700 can also include a main memory 708, preferably random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (“ROM”) or other static storage device coupled to bus 702 for storing static information and instructions for processor 704.

The computing system 700 may also include information storage mechanism 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 718, may include, for example, a hard disk, floppy disk, magnetic tape, optical disk, CD or DVD, or other fixed or removable medium that is read by and written to media drive 712. As these examples illustrate, the storage media 718 may include a computer-readable storage medium having stored therein particular computer software or data.

In some variations, information storage mechanism 710 may include other similar instrumentalities for allowing computer programs or other instructions or data to be loaded into computing system 700. Such instrumentalities may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 722 to computing system 700.

In some variations, computing system 700 can also include a communications interface 724. Communications interface 724 can be used to allow software and data to be transferred between computing system 700 and external devices. Non-limiting examples of communications interface 724 can include a modem, a network interface (such as an Ethernet or other NIC card), a communications port (such as for example, a USB port), a PCMCIA slot and card, etc. Software and data transferred via communications interface 724 are in the form of signals which can be electronic, electromagnetic, optical or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

The terms “computer program product” and “computer-readable storage medium” may be used generally to refer to media such as, for example, memory 708, storage device 718, or storage unit 722. These and other forms of computer-readable storage media may be involved in providing one or more sequences of one or more instructions to processor 704 for execution. Such instructions, generally referred to as “computer program code” (which may be grouped in the form of computer programs or other groupings), when executed, enable the computing system 700 to perform features or functions of embodiments of the apparatus and methods, described herein.

In some variations where the elements are implemented using software, the software may be stored in a computer-readable storage medium and loaded into computing system 700 using, for example, removable storage drive 712 or communications interface 724. The control logic (in this example, software instructions or computer program code), when executed by the processor 704, causes the processor 704 to perform the functions of the apparatus and methods, described herein.

It will be appreciated that, for clarity purposes, the above description has described embodiments of the apparatus and methods described herein with reference to different functional units and processors. However, it will be apparent that any suitable distribution of functionality between different functional units, processors or domains may be used without detracting from the apparatus and methods described herein. For example, functionality illustrated to be performed by separate processors or controllers may be performed by the same processor or controller. Hence, references to specific functional units are only to be seen as references to suitable means for providing the described functionality, rather than as indicative of a strict logical or physical structure or organization.

While specific components and configurations are provided above, it will be appreciated by one of ordinary skill in the art that other components variations may be used. Additionally, although a feature may appear to be described in connection with a particular embodiment, one skilled in the art would recognize that various features of the described embodiments may be combined. Moreover, aspects described in connection with an embodiment may stand alone.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category, but rather the feature may be equally applicable to other claim categories, as appropriate.

1. A working-fluid heating system comprising:
a first pipeline configured to carry a working-fluid;
a fuel heating plant comprising a first fuel heater, wherein the fuel heating plant is configured to receive at least a portion of the working-fluid carried by the first pipeline;
a solar heating plant comprising a solar heater and a second fuel heater, wherein:
the second fuel heater is downstream from the solar heater;
the second fuel heater is independent from the first fuel heater;
the solar heating plant is in parallel with the fuel heating plant; and
the solar heating plant is configured to receive at least a portion of the working-fluid carried by the first pipeline;
a second pipeline configured to receive the working-fluid from the solar heating plant and the fuel heating plant; and
a turbine for generating electricity using the working-fluid, wherein the turbine is configured to receive the working fluid from the second pipeline.

2. The system according to claim 1, wherein the solar heating plant and the fuel heating plant are configured to output the working-fluid at a predetermined temperature and at a predetermined pressure.

3. The system according to claim 1, wherein the second fuel heater comprises a pre-heater section.

4. The system according to claim 1, wherein the second fuel heater is configured to provide a maximum of 25% of the heat needed to get the working fluid to the predetermined temperature and predetermined pressure.

5. The system according to claim 1, wherein the first fuel heater comprises a fuel fired boiler configured to economize, evaporate, and superheat the working-fluid, and wherein the second fuel heater comprises an economizer and superheater.

6. A system according to claim 1, wherein less than 2% of the heat in the heated working fluid is provided by the first fuel heater and the second fuel heater.

7. A method of heating a working-fluid, the method comprising:
flowing the working fluid through a first pipeline;
flowing at least a portion of the working fluid from the first pipeline through a fuel heating plant, the fuel heating plant comprising a first fuel heater;
flowing at least a portion of the working fluid from the first pipeline through a solar heating plant, the solar heating plant comprising a solar heater and a second fuel heater, wherein:
the second fuel heater is downstream from the solar heater;
the second fuel heater is independent from the first fuel heater; and
the solar heating plant is in parallel with the fuel heating plant;
flowing the working fluid from the solar heating plant and the fuel heating plant through a second pipeline; and
flowing the working fluid from the second pipeline through a turbine for generating electricity.

8. The method according to claim 7, wherein the solar heating plant and the fuel heating plant are configured to output the working-fluid at a predetermined temperature and at a predetermined pressure.

9. The method according to claim 7, wherein the second fuel heater is configured to provide a maximum of 25% of the heat needed to get the working fluid to the predetermined temperature and predetermined pressure.

10. The method according to claim 7, wherein the first fuel heater comprises a fuel fired boiler configured to economize, evaporate, and superheat the working-fluid, and wherein the second fuel heater comprises an economizer and superheater.

11. The method according to claim 7, wherein less than 2% of the heat in the heated working fluid is provided by the first fuel heater and the second fuel heater.

12. A method of converting a full fuel-fired heating plant into a hybrid solar/fuel heating plant, the method comprising:
providing a solar heating plant, the solar heating plant comprising a solar heater and a first fuel heater, wherein:
the first fuel heater is downstream from the solar heater; and
the first fuel heater is independent from a second fuel heater of the full fuel-fired heating plant;
connecting an input of the solar heating plant to an input of the full fuel-fired heating plant; and
connecting an output of the solar heating plant to an output of the full fuel-fired heating plant.

13. The method according to claim 12, wherein the solar heating plant is configured to output a working fluid at a substantially similar pressure and temperature as the pressure and temperature of the working fluid output by the full fuel-fired heating plant.

14. A method of converting a solar heating plant into a hybrid solar/fuel heating plant, the method comprising:
providing a full fuel-fired heating plant, the full fuel-fired heating plant comprising a first fuel heater, wherein the first fuel heater is independent from a second fuel heater of the solar heating plant;
connecting an input of the full fuel-fired heating plant to an input of the solar heating plant; and
connecting an output of the full fuel-fired heating plant to an output of the solar heating plant.

15. The method according to claim 14, wherein the full fuel-fired heating plant is configured to output a working fluid at a substantially similar pressure and temperature as the pressure and temperature of the working fluid output by the solar heating plant.
